(19) United States
(12) Patent Application Publication
(10) Pub. No.: US 2018/0179343 A1
(43) Pub. Date: Jun. 28, 2018

(54) METHOD FOR MANUFACTURING WET RUBBER MASTERBATCH, METHOD FOR MANUFACTURING RUBBER COMPOSITION, AND METHOD FOR MANUFACTURING TIRE

(71) Applicant: TOYO TIRE & RUBBER CO., LTD., Itami-shi, Hyogo (JP)

(72) Inventor: Akihito Mitsui, Itami-shi (JP)

(73) Assignee: TOYO TIRE & RUBBER CO., LTD., Itami-shi, Hyogo (JP)

(21) Appl. No.: 15/738,686

(22) PCT Filed: Feb. 10, 2016
(86) PCT No.: PCT/JP2016/053969

§ 371 Date: Dec. 21, 2017

(30) Foreign Application Priority Data
Aug. 21, 2015 (JP) 2015-163580

(51) Int. Cl. C08J 3/22; B29D 30/06; B60C 1/00; C08J 3/21; C08L 7/02

(52) U.S. Cl. CPC C08J 3/22; B29D 30/0601; B29K 2007/00; C08J 3/21; C08L 7/02; B60C 1/0016

(57) ABSTRACT

A problem which is addressed is the provision of a method for manufacturing a wet rubber masterbatch and so forth permitting improvement in fatigue resistance without causing worsening in ability to achieve reduced heat generation. Wet rubber masterbatch and so forth are manufactured by means of a method comprising an operation in which a latex that comprises rubber particles for which 90 vol % particle diameter is not greater than 2 μm and that has magnesium present therein in an amount which is not greater than 150 ppm is prepared.

### TECHNICAL FIELD

The present invention relates to a method for manufacturing wet rubber masterbatch, method for manufacturing rubber composition, and method for manufacturing tire.

### BACKGROUND ART

Natural rubber latex is sometimes used as raw material for wet rubber masterbatch. Natural rubber latex contains magnesium (see, for example, Patent Reference Nos. 1 through 3). It so happens that the prior art references describe the following art. Described at Patent Reference No. 1 is art in which phosphate is added to natural rubber latex following collection thereof and the magnesium phosphate which is produced as a result is removed therefrom. Described at Patent Reference No. 2 is art in which elemental magnesium present in natural rubber latex is removed therefrom. Described at Patent Reference No. 3 is art in which DAP (diammonium phosphate) is compounded therewith in an amount that is 0.05% to 0.20% to precipitate and remove magnesium therefrom. Described at Patent Reference No. 4 is art in which a wet masterbatch is manufactured by a method including an operation in which natural rubber latex and a slurry that contains carbon black having a 90 vol % particle diameter of not greater than 10 μm are mixed together.

### PRIOR ART REFERENCES

### Patent References

PATENT REFERENCE NO. 1: Japanese Patent Application Publication Kokai No. 2004-250546
PATENT REFERENCE NO. 2: WO2010/074245
PATENT REFERENCE NO. 3: Japanese Patent Application Publication Kokai No. 2006-56930
PATENT REFERENCE NO. 4: Japanese Patent Application Publication Kokai No. 2010-150485

### SUMMARY OF INVENTION

### Problem to be Solved by Invention

There is demand for simultaneous ability to achieve fatigue resistance and reduced heat generation of vulcanized rubber. Employment of a wet rubber masterbatch instead of a dry rubber masterbatch may, for example, permit improvement in fatigue resistance and ability to achieve reduced heat generation of vulcanized rubber. However, there is still room for improvement.

There is in fact room for improvement with respect to the following points in the art of the prior art references. With the art at Patent Reference Nos. 1 through 3, it is sometimes the case that sufficient benefit in terms of improvement of ability to achieve reduced heat generation cannot be attained. This is because the art of Patent Reference Nos. 1 through 3 does not take the particle diameter of rubber particles into consideration. The art of Patent Reference No. 4 lacks any stratagem with regard to the amount of magnesium.

The present invention was conceived in light of such situation, it being an object thereof to provide a method for manufacturing a wet rubber masterbatch that permits improvement in fatigue resistance without causing worsening in ability to achieve reduced heat generation.

### Means for Solving Problem

The present inventor(s) found that fatigue resistance can be improved by reducing the amount of magnesium. The present inventor(s) discovered that processing to remove magnesium can have an effect on rubber particle diameter and also discovered that when rubber particle diameter is too large, this increases the tendency for agglomeration to occur, and that when agglomeration occurs, this causes dispersion of filler throughout the wet rubber masterbatch to become nonuniform—as a result of which ability to achieve reduced heat generation in the vulcanized rubber is made worse. The present inventor(s) perfected the present invention based on such knowledge.

That is, the present invention relates to a method for manufacturing a wet rubber masterbatch comprising filler. A method for manufacturing a wet rubber masterbatch in accordance with the present invention comprises an operation in which a latex that comprises rubber particles for which 90 vol % particle diameter is not greater than 2 μm and that has magnesium present therein in an amount which is not greater than 150 ppm is prepared. Because latex that comprises rubber particles for which 90 vol % particle diameter is not greater than 2 μm and that has magnesium which may serve as crack initiation sites in vulcanized rubber present therein in an amount which is not greater than 150 ppm is employed, it is possible to improve fatigue resistance of vulcanized rubber without causing worsening in ability to achieve reduced heat generation of the vulcanized rubber. It is preferred that the operation in which the latex is prepared comprise a step in which diammonium phosphate is added to latex raw material. It is preferred that the operation in which the latex is prepared also comprise a step in which magnesium phosphate produced as a result of the step in which diammonium phosphate was added to latex raw material is removed.

The present invention also relates to a rubber composition manufacturing method comprising a method for manufacturing a wet rubber masterbatch. Because latex that comprises rubber particles for which 90 vol % particle diameter is not greater than 2 μm and that has magnesium present therein in an amount which is not greater than 150 ppm is employed, it is possible to improve fatigue resistance of vulcanized rubber without causing worsening in ability to achieve reduced heat generation of the vulcanized rubber.

The present invention also relates to a tire manufacturing method comprising a rubber composition manufacturing method. Because latex that comprises rubber particles for which 90 vol % particle diameter is not greater than 2 μm and that has magnesium present therein in an amount which is not greater than 150 ppm is employed, it is possible to improve fatigue resistance of the tire without causing worsening in ability to achieve reduced heat generation of the tire.

### EMBODIMENTS FOR CARRYING OUT INVENTION

### Embodiment 1

A method for manufacturing a wet rubber masterbatch in accordance with a first embodiment comprises an operation in which a latex is prepared. The method for manufacturing a wet rubber masterbatch associated with the first embodiment further comprises an operation in which the latex and a slurry that comprises filler are mixed together. The method for manufacturing a wet rubber masterbatch associated with the first embodiment further comprises an operation in which a coagulant is added to a liquid mixture obtained by means of the operation in which the slurry and the latex are mixed together. The method for manufacturing a wet rubber masterbatch associated with the first embodiment further comprises an operation in which a coagulum obtained by means of the operation in which the coagulant is added to the liquid mixture is dewatered.

—Operation in which Latex is Prepared—

The operation in which the latex is prepared comprises a step in which diammonium phosphate is added to latex raw material. The operation in which the latex is prepared further comprises a step in which magnesium phosphate produced as a result of the step in which diammonium phosphate was added to latex raw material is removed.

As examples of latex raw material, liquid(s) extracted from rubber tree(s), field latex, and so forth may be cited. Latex raw material comprises magnesium.

For every 100 parts by mass of latex raw material, it is preferred that diammonium phosphate be added in an amount that is not greater than 1.2 parts by mass, more preferred that this be not greater than 1.0 part by mass, and still more preferred that this be not greater than 0.8 part by mass. Above 1.2 parts by mass, there is a tendency for the 90 vol % particle diameter to exceed 2 μm. For every 100 parts by mass of latex raw material, the lower limit of the range in values for the amount of diammonium phosphate that is added might, for example, be 0.1 part by mass. Note that water and/or the like may be further added to the latex raw material.

The latex obtained by the foregoing means comprises rubber particles for which the 90 vol % particle diameter is not greater than 2 μm. Because this is not greater than 2 μm, there being little tendency for agglomeration to occur, it has excellent stability during transport and excellent stability during storage. It therefore has good handling characteristics. On the other hand, above 2 μm, there is a tendency for the ability to achieve reduced heat generation to worsen. As examples of the lower limit of the range in values for the 90 vol % particle diameter, 1.0 μm and so forth may be cited. Magnesium is present in the latex in an amount that is not greater than 150 ppm, it being preferred that this be not greater than 140 ppm, and still more preferred that this be not greater than 130 ppm. There is no particular limitation with respect to the lower limit of the range in values for the amount of magnesium present in the latex. The 90 vol % particle diameter and the magnesium content may be adjusted primarily through adjustment of the amount of diammonium phosphate that is added.

—Operation in which Slurry and Latex are Mixed Together—

The slurry and the latex are mixed together. As examples of methods for the mixing, agitation methods involving use of high-shear mixers, high shear mixers, homomixers, ball mills, bead mills, high-pressure homogenizers, ultrasonic homogenizers, colloid mills, and other such ordinary dispersers may be cited.

The slurry comprises filler. Filler refers to carbon black, silica, clay, talc, calcium carbonate, magnesium carbonate, aluminum hydroxide, and/or other such inorganic filler(s) ordinarily used in the rubber industry. Among inorganic fillers, carbon black may in particular be favorably employed. As examples of the carbon black, besides SAF, ISAF, HAF, FEF, GPF, and other such carbon blacks ordinarily used in the rubber industry, acetylene black, Ketchen black, and/or other such electrically conductive carbon blacks may be used. The carbon black may be nongranulated carbon black or may be granulated carbon black that has been granulated based upon considerations related to the handling characteristics thereof as is ordinary practice in the rubber industry.

The slurry further comprises dispersion solvent. As examples of dispersion solvent, water and other substances that contain water and/or organic solvent may be cited. Of these, water is preferred.

—Operation in which Coagulant is Added to Liquid Mixture—

Coagulant is added to the liquid mixture obtained by means of the operation in which the slurry and the latex are mixed together. As coagulant, acid may be cited as an example. As the acid, formic acid, sulfuric acid, and the like may be cited as examples.

—Operation in which Coagulum is Dewatered—

The coagulum obtained by means of the operation in which the coagulant is added to the liquid mixture is dewatered. As the dewatering method, dewatering methods involving use of single screw extruders, ovens, vacuum dryers, air dryers, and other such drying apparatuses may be cited as examples.

The wet rubber masterbatch obtained by means of the foregoing operation comprises natural rubber and filler. For every 100 parts by mass of natural rubber, it is preferred that the amount of filler present therein be not less than 10 parts by mass, more preferred that this be not less than 20 parts by mass, and still more preferred that this be not less than 30 parts by mass. For every 100 parts by mass of natural rubber, it is preferred that the amount of filler present therein be not greater than 120 parts by mass, more preferred that this be not greater than 100 parts by mass, and still more preferred that this be not greater than 80 parts by mass.

A method for manufacturing a rubber composition associated with the first embodiment comprises an operation in which wet rubber masterbatch and compounding ingredient(s) are kneaded together. As examples of compounding ingredients, zinc oxide, stearic acid, antioxidant, wax, oil, silane coupling agent, and so forth may be cited. Rubber may be added as necessary. As examples of rubber that may be added, natural rubber, isoprene rubber (IR), butadiene rubber (BR), styrene-butadiene rubber (SBR), styrene-isoprene rubber, butadiene-isoprene rubber, styrene-butadiene-isoprene rubber, nitrile rubber (NBR), chloroprene rubber (CR), butyl rubber (IIR), and so forth may be cited.

The method for manufacturing the rubber composition associated with the first embodiment further comprises an operation in which a mixture, i.e., the mixture obtained by means of the operation in which wet rubber masterbatch and compounding ingredient(s) are kneaded together, and vulcanizing-type compounding ingredient(s) are kneaded together. As examples of vulcanizing-type compounding ingredients, sulfur, organic peroxides, and other such vulcanizing agents, vulcanization accelerators, vulcanization accelerator activators, vulcanization retarders, and so forth may be cited. As examples of the sulfur, powdered sulfur, precipitated sulfur, insoluble sulfur, high dispersing sulfur, and the like may be cited. Based upon consideration of post-vulcanization rubber properties, endurance, and so forth, it is preferred that the amount of sulfur compounded therein, expressed as equivalent sulfur content, be 0.5 part by mass to 5.0 parts by mass for every 100 parts by mass of the rubber component. As examples of vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited. For every 100 parts by mass of rubber component, it is preferred that the amount of vulcanization accelerator blended therein be 0.1 part by mass to 5.0 parts by mass.

The rubber composition obtained by means of the method associated with the first embodiment may be favorably employed in a tire, and may in particular be favorably employed in a pneumatic tire. The rubber composition may be favorably employed as a tread or other such tire member.

A method for manufacturing a tire associated with the first embodiment comprises an operation in which a green tire is made. The green tire comprises the rubber composition. The method for manufacturing the tire associated with the first embodiment further comprises an operation in which the green tire is heated.

### —Variation 1—

A slurry is made by means of a method comprising a step (I) in which latex and dispersion solvent are mixed, and a step (II) in which the dilute latex solution obtained at step (I) and filler are mixed. Employment of step (I) will permit formation of an extremely thin latex phase on all or part of the surface of the filler, and will make it possible to prevent reflocculation of filler.

### Embodiment 2

A method for manufacturing a wet rubber masterbatch in accordance with a second embodiment comprises an operation in which a latex is prepared. The method for manufacturing a wet rubber masterbatch associated with the second embodiment further comprises an operation in which filler and a first latex solution comprising at least a portion of the latex are mixed together. The method for manufacturing a wet rubber masterbatch associated with the second embodiment further comprises an operation in which a second latex solution comprising what remains of the latex, and a slurry mixture obtained by means of the operation in which the filler and the first latex solution were mixed, are mixed together. The method for manufacturing a wet rubber masterbatch associated with the second embodiment further comprises an operation in which coagulant is added to a liquid mixture obtained by means of the operation in which the second latex solution and the slurry mixture were mixed together. The method for manufacturing a wet rubber masterbatch associated with the second embodiment further comprises an operation in which a coagulum obtained by means of the operation in which the coagulant is added to the liquid mixture is dewatered.

Description will be given only with respect to the operation in which the filler and the first latex solution are mixed, i.e., the slurry mixture is obtained, and the operation in which the second latex solution and the slurry mixture are mixed together. This is because the other operations (operation in which latex is prepared, operation in which coagulant is added to the liquid mixture, and operation in which the coagulum is dewatered) were described at the first embodiment.

—Operation in which Filler and First Latex Solution are Mixed Together—

Filler and the first latex solution are mixed together. Causing filler and the first latex solution to be mixed together permits formation of an extremely thin latex phase on all or part of the surface of the filler, and makes it possible to prevent reflocculation of filler. As examples of methods for the mixing, agitation methods involving use of high-shear mixers, high shear mixers, homomixers, ball mills, bead mills, high-pressure homogenizers, ultrasonic homogenizers, colloid mills, and other such ordinary dispersers may be cited. Description of filler will be omitted. This is because it was described at the first embodiment. The first latex solution may be obtained by causing dispersion solvent and at least a portion of the latex to be mixed together. As examples of dispersion solvent, water and other substances that contain water and/or organic solvent may be cited. Of these, water is preferred. It is preferred that the solids concentration of the first latex solution be 0.1 mass % to 5 mass %, and more preferred that this be 0.2 mass % to 1.5 mass %.

—Operation in which Second Latex Solution and Slurry Mixture are Mixed Together—

The second latex solution and the slurry mixture obtained by means of the operation in which filler and the first latex solution were mixed are mixed together. As examples of methods for the mixing, agitation methods involving use of high-shear mixers, high shear mixers, homomixers, ball mills, bead mills, high-pressure homogenizers, ultrasonic homogenizers, colloid mills, and other such ordinary dispersers may be cited.

The second latex solution may be obtained by causing dispersion solvent and what remains of the latex to be mixed together. It is preferred that the solids concentration of the second latex solution be 10 mass % to 60 mass %, and more preferred that this be 20 mass % to 30 mass %.

Description with respect to a rubber composition manufacturing method and description with respect to a tire manufacturing method are omitted. This is because they were described at the first embodiment.

### Working Examples

Working examples and the like which illustrate the constitution and effect of the present invention in specific terms are described below. The raw materials employed were as follows.

### Raw Materials Employed

DAP Diammonium hydrogen phosphate manufactured by Wako Pure Chemical Industries, Ltd.
Coagulant Formic acid (reagent-grade 85%; diluted to obtain 10% solution; pH adjusted to 1.2) manufactured by Nacalai Tesque, Inc.
N330 (carbon black) “SEAST 3” manufactured by Tokai Carbon Co., Ltd.
Zinc oxide “Zinc Oxide No. 1” manufactured by Mitsui Mining & Smelting Co., Ltd.
Stearic acid “LUNAC S-20” manufactured by Kao Corporation
Wax “OZOACE 0355” manufactured by Nippon Seiro Co., Ltd.
Antioxidant A “NOCRAC 6C” manufactured by Ouchi Shinko Chemical Industrial Co., Ltd.
Antioxidant B “RD” manufactured by Ouchi Shinko Chemical Industrial Co., Ltd.
Sulfur “Powdered Sulfur” manufactured by Tsurumi Chemical Industry Co., Ltd.
Vulcanization accelerator “NOCCELER NS-P” manufactured by Ouchi Shinko Chemical Industrial Co., Ltd.

### Comparative Example 1

### —Manufacture of Wet Rubber Masterbatch—

Natural rubber latex was collected, and in accordance with TABLE 1, the natural rubber latex and the carbon black slurry were mixed together, and formic acid was added to the liquid mixture to obtain a coagulum. A Model V-02 screw press (squeezer-type single-screw dewatering extruder) manufactured by Suehiro EPM Corporation was used to dry the coagulum until water content was not greater than 1.5% to manufacture a wet rubber masterbatch.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Example 2

### —Manufacture of Natural Rubber—

Natural rubber latex was collected, DAP as a fraction of the total weight of the natural rubber latex was added in the amount shown at TABLE 1, and the magnesium phosphate which precipitated was removed therefrom to obtain a liquid supernatant. Formic acid was added to the liquid supernatant to obtain a coagulum. A Model V-02 screw press (squeezer-type single-screw dewatering extruder) manufactured by Suehiro EPM Corporation was used to dry the coagulum until water content was not greater than 1.5% to manufacture natural rubber.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Example 3 and Working Examples 1-3

### —Manufacture of Wet Rubber Masterbatch—

Natural rubber latex was collected, DAP as a fraction of the total weight of the natural rubber latex was added in the amount shown at TABLE 1, and the magnesium phosphate which precipitated was removed therefrom to obtain a liquid supernatant. In accordance with TABLE 1, the liquid supernatant and the carbon black slurry were mixed together, and formic acid was added to the liquid mixture to obtain a coagulum. A Model V-02 screw press (squeezer-type single-screw dewatering extruder) manufactured by Suehiro EPM Corporation was used to dry the coagulum until water content was not greater than 1.5% to manufacture a wet rubber masterbatch.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Example 4

### —Manufacture of Natural Rubber—

Natural rubber latex was collected, and formic acid was added to the natural rubber latex to obtain a coagulum. A Model V-02 screw press (squeezer-type single-screw dewatering extruder) manufactured by Suehiro EPM Corporation was used to dry the coagulum until water content was not greater than 1.5% to manufacture natural rubber.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### First Evaluation

### —Magnesium Content—

Magnesium content of liquid supernatant—Comparative Examples 2-3 and Working Examples 1-3—was measured in accordance with ISO 11852; 2011. Magnesium content of natural rubber latex—Comparative Examples 1 and 4—was measured in accordance with ISO 11852; 2011.

### —90 Vol % Particle Diameter—

D90 (μm) of liquid supernatant—Comparative Examples 2-3 and Working Examples 1-3—was measured using a “SALD 2200” manufactured by Shimadzu Corporation (latex refractive index: 1.6-0.10i), absorbance being set to 0.05 to 0.1 at the time of measurement. D90 (μm) of natural rubber latex—Comparative Examples 1 and 4—was measured under the same conditions.

### —Presence of Absence of Coagulated Mass Following Shaking—

Following shaking for 1 minute of liquid supernatant—Comparative Examples 2-3 and Working Examples 1-3—using a uniaxial shaker, visual inspection was carried out to determine whether a coagulated mass was present. Following shaking for 1 minute of natural rubber latex—Comparative Examples 1 and 4—using a uniaxial shaker, visual inspection was carried out to determine whether a coagulated mass was present.

### Second Evaluation: Properties of Vulcanized Rubber

The rubber composition was vulcanized at conditions of 150° C. for 30 min to obtain vulcanized rubber. Fatigue resistance and heat generation of the vulcanized rubber were evaluated. Conditions under which evaluation was performed are as indicated below. Results are shown in TABLE 1.

### —Fatigue Resistance—

Performance of vulcanized rubber with respect to fatigue resistance was evaluated in accordance with JIS K 6260 (flex cracking testing). Results of evaluation are shown as indexed relative to a value of 100 for Comparative Example 1. This means that the larger the value the more excellent it was in terms of performance with respect to fatigue resistance.

### —Heat Generation—

Heat generation of vulcanized rubber was evaluated using loss tangent tan δ in accordance with JIS K 6265. Measurements were carried out under conditions of 50 Hz, 80° C., and dynamic strain 2% using an E4000 rheospectrometer manufactured by UBM. Results of evaluation are shown as indexed relative to a value of 100 for Comparative Example 1. This means that the smaller the value the lower—and thus the better—was the heat generation.

TABLE 1

| | | Comparative | Comparative | Comparative | Working | Working | Working | Comparative |
|---|---|---|---|---|---|---|---|---|
| | | Example 1 | Example 2 | Example 3 | Example 1 | Example 2 | Example 3 | Example 4 |
| Amount of DAP added mass % | | — | 0.82 | 1.31 | 0.5 | 0.82 | 1.07 | |
| Evaluation | Magnesium content | 190 | 104 | 68 | 120 | 104 | 90 | 190 |
| | ppm | | | | | | | |
| | D90 particle diameter | 1.37 | 1.53 | 3.43 | 1.55 | 1.53 | 1.90 | 1.37 |
| | μm | | | | | | | |
| | Coagulated mass | Absent | Absent | Present | Absent | Absent | Absent | Absent |

Wet rubber masterbatch

| | | | | | | | | |
|---|---|---|---|---|---|---|---|---|
| Amount (parts | Natural rubber | 100 | — | 100 | 100 | 100 | 100 | — |
| by mass) | N330 | 50 | — | 50 | 50 | 50 | 50 | — |

Rubber composition

| | | | | | | | | |
|---|---|---|---|---|---|---|---|---|
| Amount (parts | Natural rubber | — | 100 | — | — | — | — | 100 |
| by mass) | N330 | — | 50 | — | — | — | — | 50 |
| | Wet rubber masterbatch | 150 | — | 150 | 150 | 150 | 150 | — |
| | Zinc oxide | 3 | 3 | 3 | 3 | 3 | 3 | 3 |
| | Stearic acid | 2 | 2 | 2 | 2 | 2 | 2 | 2 |
| | Wax | 1 | 1 | 1 | 1 | 1 | 1 | 1 |
| | Antioxidant (A) | 2 | 2 | 2 | 2 | 2 | 2 | 2 |
| | Antioxidant (B) | 1 | 1 | 1 | 1 | 1 | 1 | 1 |
| | Sulfur | 2 | 2 | 2 | 2 | 2 | 2 | 2 |
| | Vulcanization | 1 | 1 | 1 | 1 | 1 | 1 | 1 |
| | accelerator | | | | | | | |

Vulcanized rubber

| | | | | | | | | |
|---|---|---|---|---|---|---|---|---|
| Evaluation | Fatigue resistance | 100 | 83 | 97 | 130 | 129 | 129 | 77 |
| | (relative to index value) | | | | | | | |
| | Heat generation (relative | 100 | 111 | 106 | 99 | 99 | 100 | 111 |
| | to index value) | | | | | | | |

At Working Example 1, where DAP was 0.5 mass %, fatigue resistance was better than at Comparative Example 1. And at Working Example 2 as well, i.e., the example in which DAP was 0.82 mass %, fatigue resistance was better than at Comparative Example 1. And at Working Example 3 as well, i.e., the example in which DAP was 1.07 mass %, fatigue resistance was better than at Comparative Example 1. At Working Examples 1-3, a coagulated mass was not observed to be present. On the other hand, at Comparative Example 3, i.e., the example in which DAP was 1.31 mass %, a coagulated mass was observed to be present. It is speculated that rubber particles within the liquid supernatant may have become too large, increasing the tendency for agglomeration to occur. It is speculated that it was for this reason that the wet rubber masterbatch of Comparative Example 3 was nonuniform. At Comparative Example 3, fatigue resistance and ability to achieve reduced heat generation were worse than at Comparative Example 1. It is speculated that the wet rubber masterbatch of Comparative Example 3 was nonuniform.

At Comparative Example 2, i.e., the example in which DAP was added in an amount that was 0.82 mass % to manufacture natural rubber, fatigue resistance and ability to achieve reduced heat generation were worse than at Comparative Example 1. Note that Comparative Example 1 had better fatigue resistance and ability to achieve reduced heat generation than Comparative Example 4, Comparative Example 4 being an example in which dry-blending was carried out.

### Comparative Example 5

### —Manufacture of Wet Rubber Masterbatch—

Natural rubber latex was collected. Water was added to a portion of the natural rubber latex to manufacture a dilute natural rubber latex solution having a solids (rubber) concentration that was 0.5 mass %. Water was added to what remained of the natural rubber latex to manufacture a natural rubber latex solution having a solids (rubber) concentration that was 28 mass %. 50 parts by mass of carbon black was added to the dilute natural rubber latex solution, and an agitator manufactured by Silverson (Flashblend) was used to disperse the carbon black (Flashblend conditions: 3600 rpm; 30 min) to manufacture a “carbon-black-containing slurry solution” (fine dispersal operation). Natural rubber latex solution was added to the “carbon-black-containing slurry solution” in such amount as to cause solids content (rubber) as a fraction thereof together with the dilute natural rubber latex solution employed at the fine dispersal operation to be 100 parts by mass. A mixer (SMV-20 SUPERMIXER) manufactured by Kawata Co., Ltd., was used to carry out agitation to manufacture a “carbon-black-containing natural rubber latex solution”. The “carbon-black-containing natural rubber latex solution” was maintained at 90° C. while a 10 mass % aqueous solution of formic acid was added thereto in an amount sufficient to achieve a pH of 4 to obtain a coagulum. A Model V-02 screw press (squeezer-type single-screw dewatering extruder) manufactured by Suehiro EPM Corporation was used to dry the coagulum until water content was not greater than 1.5% to manufacture a wet rubber masterbatch.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Example 6

### —Manufacture of Natural Rubber—

Natural rubber latex was collected, DAP as a fraction of the total weight of the natural rubber latex was added in the amount shown at TABLE 1, and the magnesium phosphate which precipitated was removed therefrom to obtain a liquid supernatant. Formic acid was added to the liquid supernatant to obtain a coagulum. A Model V-02 screw press (squeezer-type single-screw dewatering extruder) manufactured by Suehiro EPM Corporation was used to dry the coagulum until water content was not greater than 1.5% to manufacture natural rubber.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### Comparative Example 7 and Working Examples 4-6

### —Manufacture of Wet Rubber Masterbatch—

Natural rubber latex was collected, DAP as a fraction of the total weight of the natural rubber latex was added in the amount shown at TABLE 1, and the magnesium phosphate which precipitated was removed therefrom to obtain a liquid supernatant. Water was added to a portion of the liquid supernatant to manufacture a dilute natural rubber latex solution having a solids (rubber) concentration that was 0.5 mass %. Water was added to what remained of the liquid supernatant to manufacture a natural rubber latex solution having a solids (rubber) concentration that was 28 mass %. 50 parts by mass of carbon black was added to the dilute natural rubber latex solution, and an agitator manufactured by Silverson (Flashblend) was used to disperse the carbon black (Flashblend conditions: 3600 rpm; 30 min) to manufacture a “carbon-black-containing slurry solution” (fine dispersal operation). Natural rubber latex solution was added to the “carbon-black-containing slurry solution” in such amount as to cause solids content (rubber) as a fraction thereof together with the dilute natural rubber latex solution employed at the fine dispersal operation to be 100 parts by mass. A mixer (SMV-20 SUPERMIXER) manufactured by Kawata Co., Ltd., was used to carry out agitation to manufacture a “carbon-black-containing natural rubber latex solution”. The “carbon-black-containing natural rubber latex solution” was maintained at 90° C. while a 10 mass % aqueous solution of formic acid was added thereto in an amount sufficient to achieve a pH of 4 to obtain a coagulum. A Model V-02 screw press (squeezer-type single-screw dewatering extruder) manufactured by Suehiro EPM Corporation was used to dry the coagulum until water content was not greater than 1.5% to manufacture a wet rubber masterbatch.

### —Manufacture of Rubber Composition—

The respective compounding ingredients were blended in amounts as listed at TABLE 1, and a Model B Banbury mixer manufactured by Kobe Steel, Ltd., was used to knead these together to manufacture a rubber composition.

### First Evaluation

### —Magnesium Content—

Magnesium content of liquid supernatant—Comparative Examples 6-7 and Working Examples 4-6—was measured in accordance with ISO 11852; 2011. Magnesium content of natural rubber latex—Comparative Example 5—was measured in accordance with ISO 11852; 2011.

### —90 Vol % Particle Diameter—

D90 (μm) of liquid supernatant—Comparative Examples 6-7 and Working Examples 4-6—was measured using a “SALD 2200” manufactured by Shimadzu Corporation (latex refractive index: 1.6-0.10i), absorbance being set to 0.05 to 0.1 at the time of measurement. D90 (μm) of natural rubber latex—Comparative Example 5—was measured under the same conditions.

### —Presence of Absence of Coagulated Mass Following Shaking—

Following shaking for 1 minute of liquid supernatant Comparative Examples 6-7 and Working Examples 4-6—using a uniaxial shaker, visual inspection was carried out to determine whether a coagulated mass was present. Following shaking for 1 minute of natural rubber latex—Comparative Example 5—using a uniaxial shaker, visual inspection was carried out to determine whether a coagulated mass was present.

### Second Evaluation: Properties of Vulcanized Rubber

The rubber composition was vulcanized at conditions of 150° C. for 30 min to obtain vulcanized rubber. Fatigue resistance and heat generation of the vulcanized rubber were evaluated. Conditions under which evaluation was performed are as indicated below. Results are shown in TABLE 2.

### —Fatigue Resistance—

Performance of vulcanized rubber with respect to fatigue resistance was evaluated in accordance with JIS K 6260 (flex cracking testing). Results of evaluation are shown as indexed relative to a value of 100 for Comparative Example 5. This means that the larger the value the more excellent it was in terms of performance with respect to fatigue resistance.

### —Heat Generation—

Heat generation of vulcanized rubber was evaluated using loss tangent tan δ in accordance with JIS K 6265. Measurements were carried out under conditions of 50 Hz, 80° C., and dynamic strain 2% using an E4000 rheospectrometer manufactured by UBM. Results of evaluation are shown as indexed relative to a value of 100 for Comparative Example 5. This means that the smaller the value the lower—and thus the better—was the heat generation.

TABLE 2

| | | Comparative | Comparative | Comparative | Working | Working | Working |
|---|---|---|---|---|---|---|---|
| | | Example 5 | Example 6 | Example 7 | Example 4 | Example 5 | Example 6 |
| Amount of DAP added mass % | | — | 0.82 | 1.31 | 0.5 | 0.82 | 1.07 |
| Evaluation | Magnesium content | 190 | 104 | 68 | 120 | 104 | 90 |
| | ppm | | | | | | |
| | D90 particle diameter | 1.37 | 1.53 | 3.43 | 1.55 | 1.53 | 1.90 |
| | μm | | | | | | |
| | Coagulated mass | Absent | Absent | Present | Absent | Absent | Absent |

Wet rubber masterbatch

| | | | | | | | |
|---|---|---|---|---|---|---|---|
| Blended amount | Natural rubber | 100 | — | 100 | 100 | 100 | 100 |
| (parts by mass) | N330 | 50 | — | 50 | 50 | 50 | 50 |

Rubber composition

| | | | | | | | |
|---|---|---|---|---|---|---|---|
| Blended amount | Natural rubber | — | 100 | — | — | — | — |
| (parts by mass) | N330 | — | 50 | — | — | — | — |
| | Wet rubber masterbatch | 150 | — | 150 | 150 | 150 | 150 |
| | Zinc oxide | 3 | 3 | 3 | 3 | 3 | 3 |
| | Stearic acid | 2 | 2 | 2 | 2 | 2 | 2 |
| | Wax | 1 | 1 | 1 | 1 | 1 | 1 |
| | Antioxidant (A) | 2 | 2 | 2 | 2 | 2 | 2 |
| | Antioxidant (B) | 1 | 1 | 1 | 1 | 1 | 1 |
| | Sulfur | 2 | 2 | 2 | 2 | 2 | 2 |
| | Vulcanization | 1 | 1 | 1 | 1 | 1 | 1 |
| | accelerator | | | | | | |

Vulcanized rubber

| | | | | | | | |
|---|---|---|---|---|---|---|---|
| Evaluation | Fatigue resistance | 100 | 81 | 100 | 138 | 131 | 133 |
| | (relative to index value) | | | | | | |
| | Heat generation (relative | 100 | 110 | 105 | 98 | 99 | 100 |
| | to index value) | | | | | | |

At Working Example 4, where DAP was 0.5 mass %, fatigue resistance was better than at Comparative Example 5. And at Working Example 5 as well, i.e., the example in which DAP was 0.82 mass %, fatigue resistance was better than at Comparative Example 5. And at Working Example 6 as well, i.e., the example in which DAP was 1.07 mass %, fatigue resistance was better than at Comparative Example 5. At Working Examples 4-6, a coagulated mass was not observed to be present. On the other hand, at Comparative Example 7, i.e., the example in which DAP was 1.31 mass %, a coagulated mass was observed to be present. It is speculated that rubber particles within the liquid supernatant may have become too large, increasing the tendency for agglomeration to occur. It is speculated that it was for this reason that the wet rubber masterbatch of Comparative Example 7 was nonuniform. At Comparative Example 7, ability to achieve reduced heat generation was worse than at Comparative Example 1. It is speculated that the wet rubber masterbatch of Comparative Example 7 was nonuniform.

1. A method for manufacturing a wet rubber masterbatch comprising filler, the method for manufacturing the wet rubber masterbatch comprising:
an operation in which a latex that comprises rubber particles for which 90 vol % particle diameter is not greater than 2 μm and that has magnesium present therein in an amount which is not greater than 150 ppm is prepared.

2. The method for manufacturing the wet rubber masterbatch according to claim 1 wherein the operation in which the latex is prepared comprises
a step in which diammonium phosphate is added to latex raw material; and
a step in which magnesium phosphate produced as a result of the foregoing step is removed.

3. A rubber composition manufacturing method comprising the method for manufacturing the wet rubber masterbatch according to claim 1.

4. A tire manufacturing method comprising the method for manufacturing the wet rubber masterbatch according to claim 1.

5. The method for manufacturing the wet rubber masterbatch according to claim 1, the method further comprising:
an operation in which the latex and a slurry that comprises the filler are mixed together.

6. The method for manufacturing the wet rubber masterbatch according to claim 5, the method further comprising:
an operation in which a coagulant is added to a liquid mixture obtained by means of the operation in which the slurry and the latex are mixed together.
